(19) United States
(12) Patent Application Publication
(10) Pub. No.: US 2013/0139499 A1
(43) Pub. Date: Jun. 6, 2013

(54) SUPPORT UNIT FOR A DEVICE FOR RECOVERING ENERGY FROM MARINE AND FLUVIAL CURRENTS

(71) Applicant: Yves Kerckove, Pegomas (FR)

(72) Inventor: Yves Kerckove, Pegomas (FR)

(21) Appl. No.: 13/577,240

(22) PCT Filed: Feb. 8, 2011
(86) PCT No.: PCT/FR11/00077

§ 371 Date: Oct. 26, 2012

(30) Foreign Application Priority Data
Feb. 9, 2010 (FR) 1000513
Feb. 17, 2010 (FR) 1000666
Apr. 1, 2010 (FR) 1001373
Apr. 7, 2010 (FR) 1001435

(51) Int. Cl. F03B 13/26; F03B 17/06

(52) U.S. Cl. CPC F03B 13/26; F03B 17/06
USPC 60/504

(57) ABSTRACT

The present invention relates to a support unit for attaching a device for recovering energy from a marine or fluvial current, characterized in that said support unit includes at least one mooring (1) and a main buoy rope (2) extending from the mooring (1), said buoy rope (2) including at least one mounting point (4) to which at least one energy recovery device is attached. The invention is used for recovering energy from marine and fluvial currents. The support unit according to the invention is configured to work on the surface, in the pelagic zone, or close to the seabed.

The invention relates to a support unit for attaching a device for recovering energy from marine and fluvial currents.

This unit, which is composed of cables, buoy ropes, boards of the otter boards type, buoys and/or moorings is intended for tethering sea devices capable of recovering energy from marine currents. This unit shall be so positioned in and on the path of a marine current, whether it is linear or tidal, as to enable a device able to recover energy from marine currents to operate under the best possible conditions, whether on the surface or in the pelagic zone, and whatever the marine depth existing under the beaches or strata selected for such a recovery.

For this purpose, the invention relates to a support unit intended for fixing a device for recovering energy from marine or fluvial currents, characterized in that it comprises at least one mooring and one main buoy rope extending from the mooring, with said buoy rope comprising several attachment points on each one of which at least one sling is fixed, whereon at least one device for recovering energy is fixed.

The invention makes it possible to operate devices for recovering energy from a support unit forming a frame.

According to preferred alternative but not restrictive solutions of the invention, the support unit is such that:
it comprises a plurality of slings fixed to at least one attachment point of the main buoy rope and connected with each other so as to form a frame and buoy ropes retaining said device for recovering energy are attached at the crossing of the slings.
it comprises, at the crossing of the slings, a mean for fixing whereon at least one device for recovering energy is fixed.
   The mean for fixing comprises a ballasted buoy comprising at least one float intended to provide the buoyancy of the buoy, and a mounting trunnion intended for fixing a buoy rope connected to a device for recovering energy.
   The buoy comprises attachment points intended for receiving slings and/or buoy ropes connecting a mooring,
   the buoy comprises, on the mounting trunnion, a rotating sealed electrical contact intended for providing the connexion with at least one electric cable extending from at least one device for recovering energy.
the buoy comprises a duct going through the height thereof from the mounting trunnion, through which goes an electric cable intended for transporting the power produced by the device for recovering energy.
it comprises a floating electric box attached between slings and so configured as to receive at least one electric cable from the device for recovering energy.
the electric box comprises at least one electric cable intended for transporting the electricity produced by the device for recovering energy.
the slings comprise a sleeve enclosing air so as to balance the weight thereof.

The invention also relates to a system for recovering energy comprising a support unit according to any one of the preceding claims, characterized in that it comprises at least one device for recovering energy comprising: at least one hydrodynamic float, at least one power generator comprising at least one turbine, at least one power generator holder and at least a ballasted keel providing stability to the device, said power generator is held under the float by the holder so that the height separating the end of the keel from the axis of rotation of the turbine is at least equal to 20% of the height between the axis of rotation of the turbine and the lower face of the float.

According to optional or complementary alternative solutions:
This sea device, composed of cables, buoy ropes, otter boards, moorings and buoys, is intended for positioning, in a tidal current, devices for recovering energy from said tidal currents, characterized in that it is positioned in a plane parallel to the surface, in one or more stratum(a) or layer(s), independently of the depth of the sea floor thereunder,
   in that the device is positioned in a tidal current, using moorings and buoy ropes and in that it comprises, at the desired levels for operating the (Kerckove Type 1 or other types of) devices for recovering energy, attachment points in the form of metal buoys, whereon sling frames are tethered.
boards of the otter board type may be used alternately. Transversal slings will limit this spacing. The number thereof is not limited. Rigid parts can also be used instead of slings and the function of the assembly shall not be modified.
a series of longitudinal slings will respond to the tension of the devices for recovering energy. The number thereof is not limited and they can be rigid too,
the frame shall have undetermined dimensions, it shall be extensible, like a Mécano® if so required, across the whole effective width of the tidal current, through the addition of new appropriate slings, buoys, fasteners, buoy ropes and moorings,
   the length of the frame is indefinite and can even be infinite. It shall just be necessary to provide for the required number of longitudinal and lateral moorings, of buoy ropes, of buoys and boards, and of slings.
theoretically, the number of layers or strata is unlimited. As there is no limit, from the marine point of view, as to the quantity of operational places (unlimited possibilities), there is no reason, considering the present state of the art and the needs, for increasing the number of strata in depth, although this remains possible and desirable in the future.
   Such units can also be given other geometric shapes but the operating principle of such units will not be affected thereby.
in order to facilitate positioning and maintenance operations, the slings can be placed in flexible tubes of the polyvinyl type, or another type, which shall contain enough air to counterbalance their weight and make these float below the water surface. The pipes shall be heat-welded at the ends of the slings,
   the parts connecting the slings can be buoys or mechano-welded parts, but can also have other shapes, be made of other materials, depending on the circumstances and this will not affect the searched goal
a sea device, i.e. a universal support operating in alternative motion currents called tides, intended for being the geo-located and pelagic support enabling devices for recovering tidal energy equipped with uni-directional hydro-electric turbines to transmit the energy produced by said recovering devices toward the places where such energy is used, whereas they are submitted to random rotating constraints in addition to the alternative constraints,
a sea device, characterized in that it is composed of a central float, i.e. a float divided into two parts, the one providing buoyancy with all appropriate means, and the other one, which can be located in the lower part or in the upper part thereof, being intended for receiving the electric connections, in a way a sealed floating joint box, having an extremely solid construction and the perimeter of which will be equipped with tethering means,
a sea device, characterized in that it is composed of peripheral floats which can be ballasted as requested, having a shape and a volume suitable for each case, comprising, in the lower part thereof, an adjustable attachment means making it possible to tether it with a buoy rope to a mooring, which will be positioned on the sea floor, and the perimeter of which will be equipped with fasteners making it possible to connect it with other floats similar to the central float, the apex of which will be equipped with a mounting trunnion provided with a safety fastening system, making it possible to receive a device for recovering energy from the sea, rotating by 360° on the spot, in a constant way,
peripheral floats characterized in that they will be connected with <<Kerckove Type 1 >> or other types of devices for recovering energy from the current, the apex of which will be equipped with a curved antenna mounted on a sealed electrical contactor rotating by 360°, and this antenna will make it possible to recover the energy produced by said recovering devices and to transmit such energy on the electric cable, to the central float used as a joint box, and an outlet can also be provided for the energy through the lower part of the device, preferably along a buoy rope,
   a device characterized in that at least 2 “Kerckove Type 1 >> or other types of devices for recovering energy are required for making it exist, but the number can also be 3 or any infinite number, remembering that the number of permissible devices for recovering energy will depend on the possibility to locate these at sea, with the flatness of the sea floor being the main element, but that positioning 2 devices for recovering energy will be possible everywhere.
   This sea device, composed of cables, buoy ropes, otter boards, moorings and buoys, is intended for positioning, in a tidal current, devices for recovering energy from said tidal currents, characterized in that it is positioned in one or more stratum(a) or layer(s), independently of the depth of the sea floor thereunder,
   the link between the slings shall be provided by a specific connection buoy
the connection buoy being characterized in that it makes it possible to place <<Kerckove Type 1 >> or other types of devices for recovering energy from the tidal currents, within said tidal currents, through the tethering of said devices for recovering energy to said connection buoy,
the connection buoy being characterized in that it can float and the shape and dimensions thereof are adapted to each situation, and in that it will receive peripheral attachment points enabling the connection with other buoys through slings,
the connection buoy being characterized in that it comprises the mean for fixing for being connected to moorings through cables or buoy ropes and in that such means for fixing will be doubled to hold it in place, upstream as well as downstream and in that such means will be provided as necessary, comprising sideways,
the connection buoy being characterized in that it will comprise a hollow central axle, the apex of which will be equipped with a mounting trunnion making it possible to lock a rotating part therein, in order to receive the end of the buoy rope of the Kerckove Type 1 or other types of devices for recovering energy from tidal currents,
the connection buoy being characterized in that a sealed rotating electrical contactor shall be provided in the upper part of the central axle, where the electric cable from the device for recovering energy from tidal current shall be connected, and shall enable the electric cable to transmit the energy produced to the place where it is used through the hollow central axle,
the connection buoy being characterized in that it can be provided with additional buoys if balancing is required, and in that ballast can also be used.

Other characteristics, aims and advantages of the present invention will appear upon reading the following detailed description and referring to the appended drawings given as non restrictive examples and wherein:

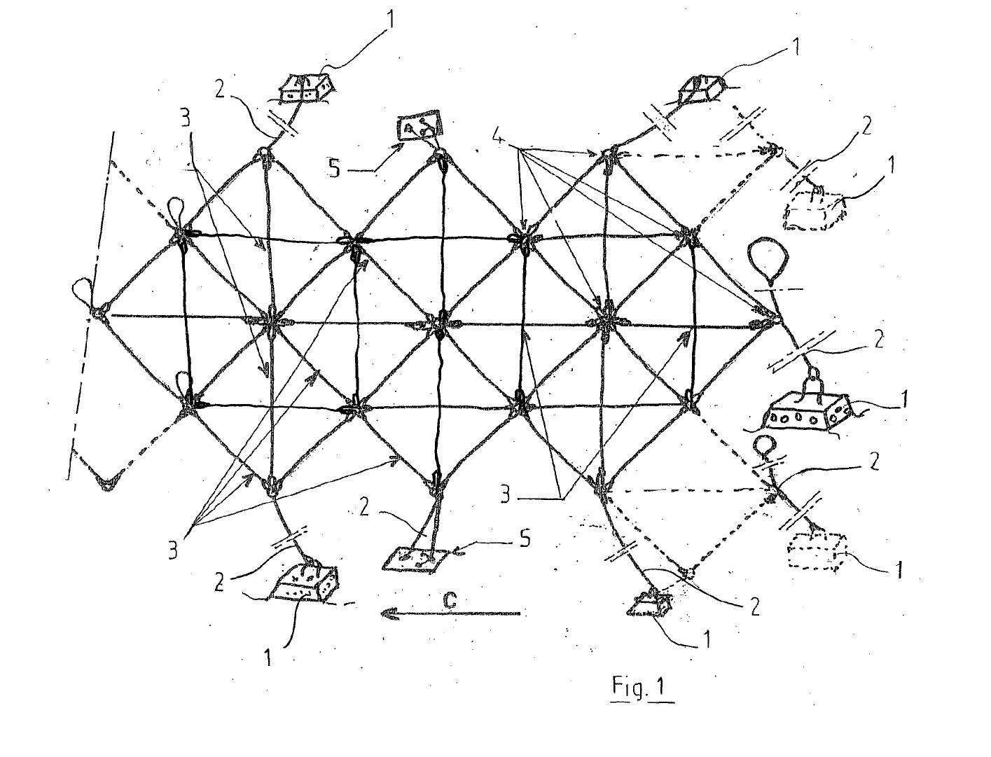

FIG. 1 shows a system according to a first embodiment of the invention;

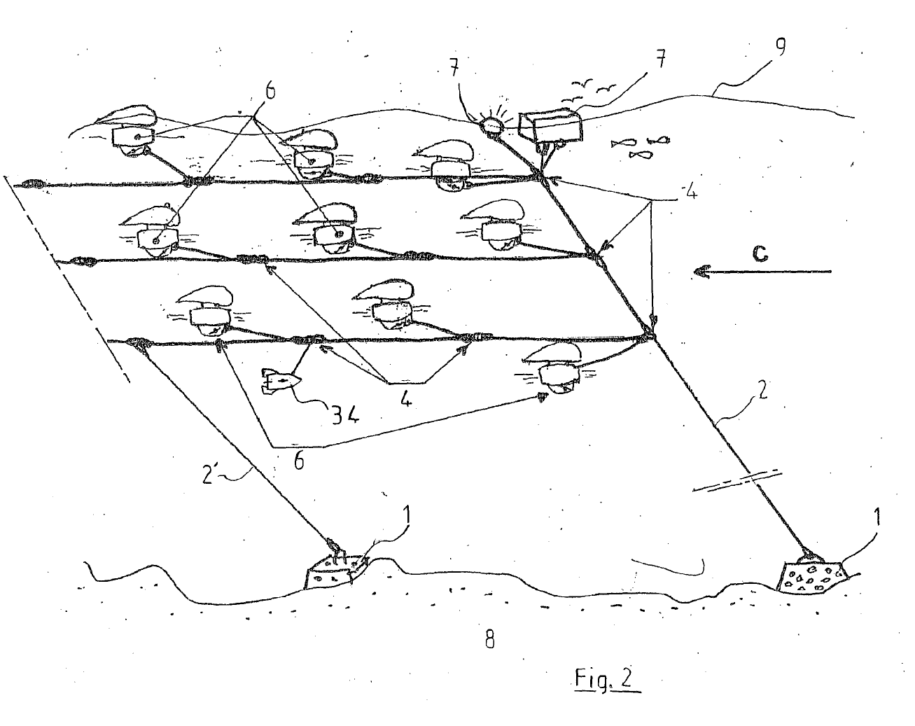

FIG. 2 shows a support unit according to a second embodiment of the invention;

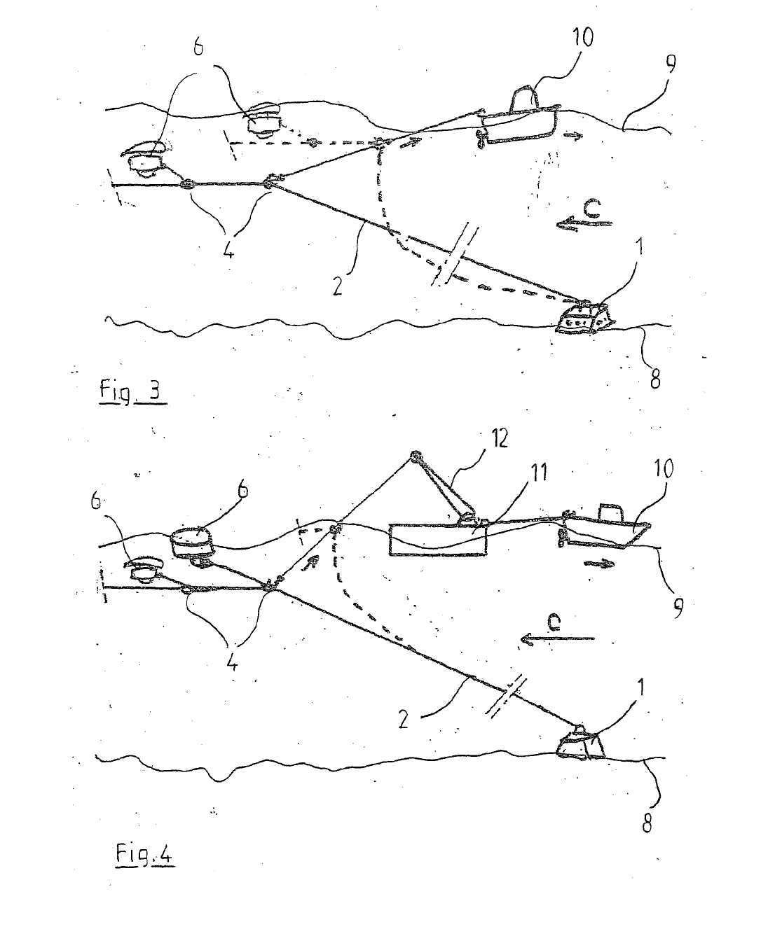

FIGS. 3 and 4 illustrate two possible towing of the support unit according to FIG. 2.

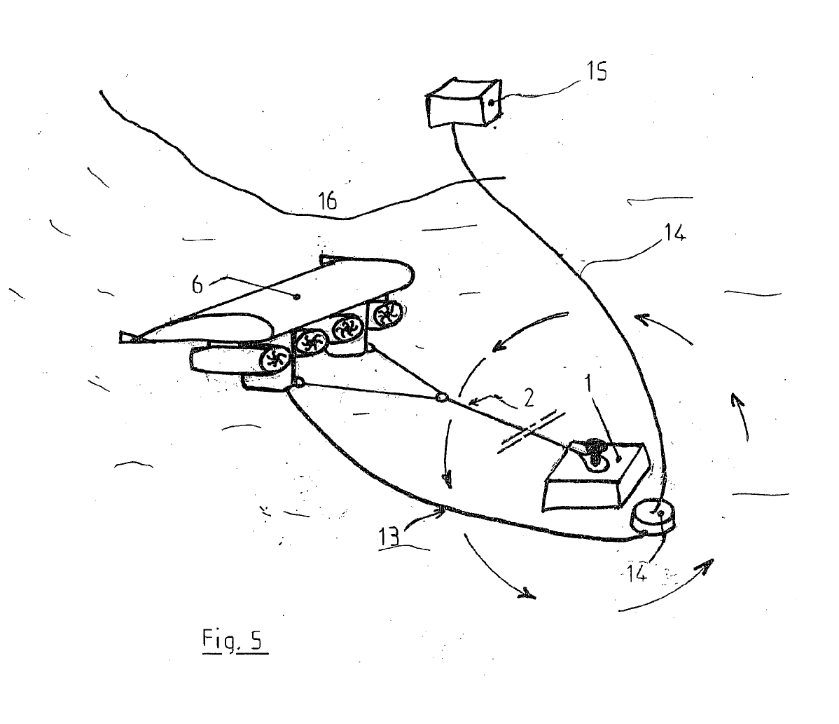

FIG. 5 shows the fixing and the electric connections of a device for recovering energy according to a first alternative solution for a uni-directional stream of a current.

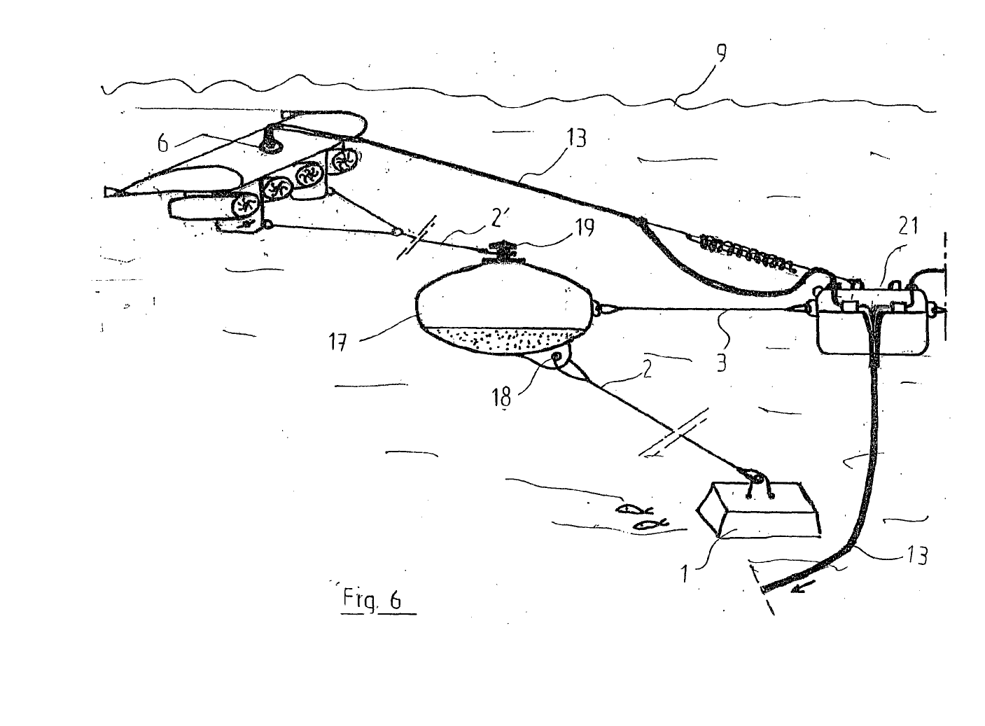

FIG. 6 shows the fixing and the electric connections of a device for recovering energy according to a second alternative solution for a turning bi-directional stream of a current.

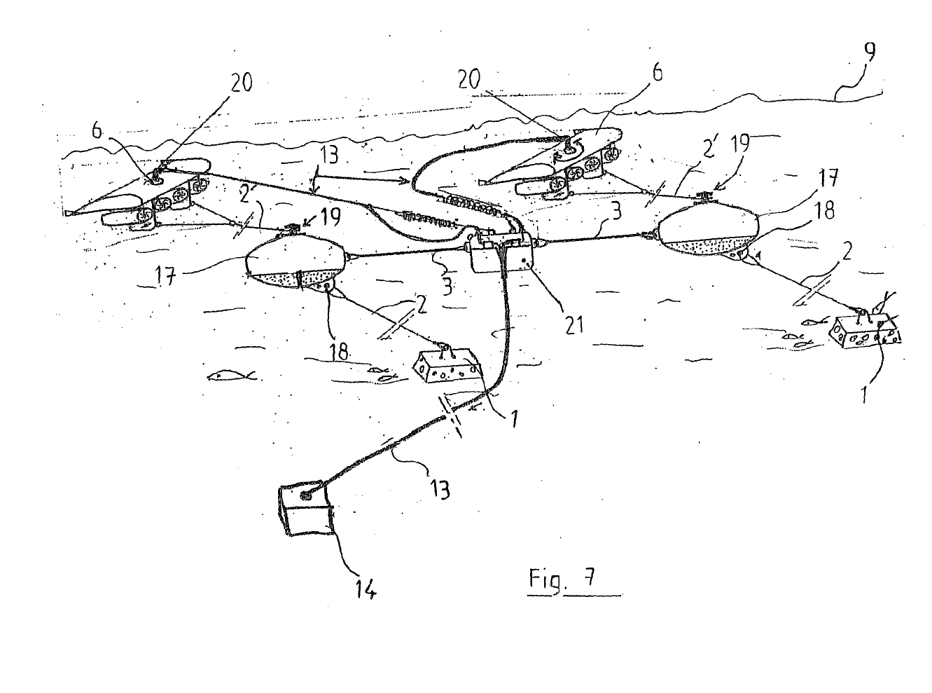

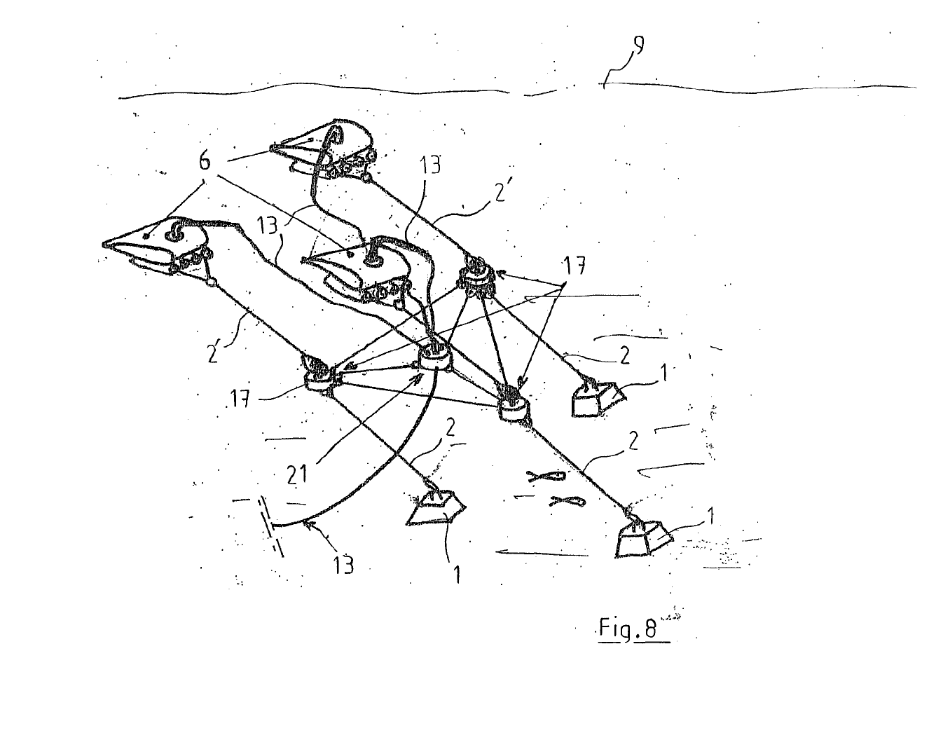

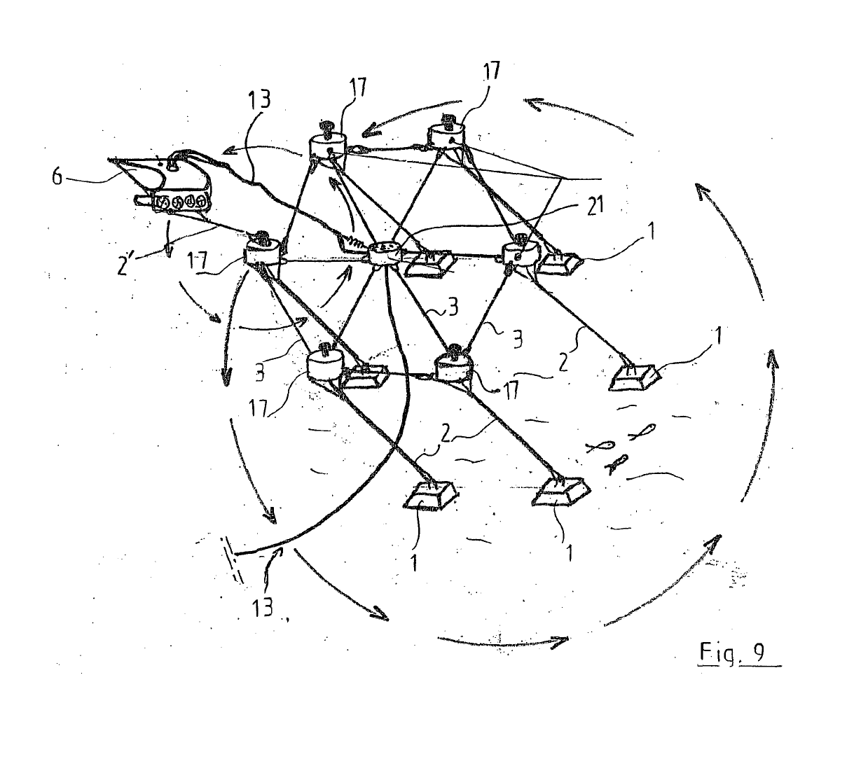

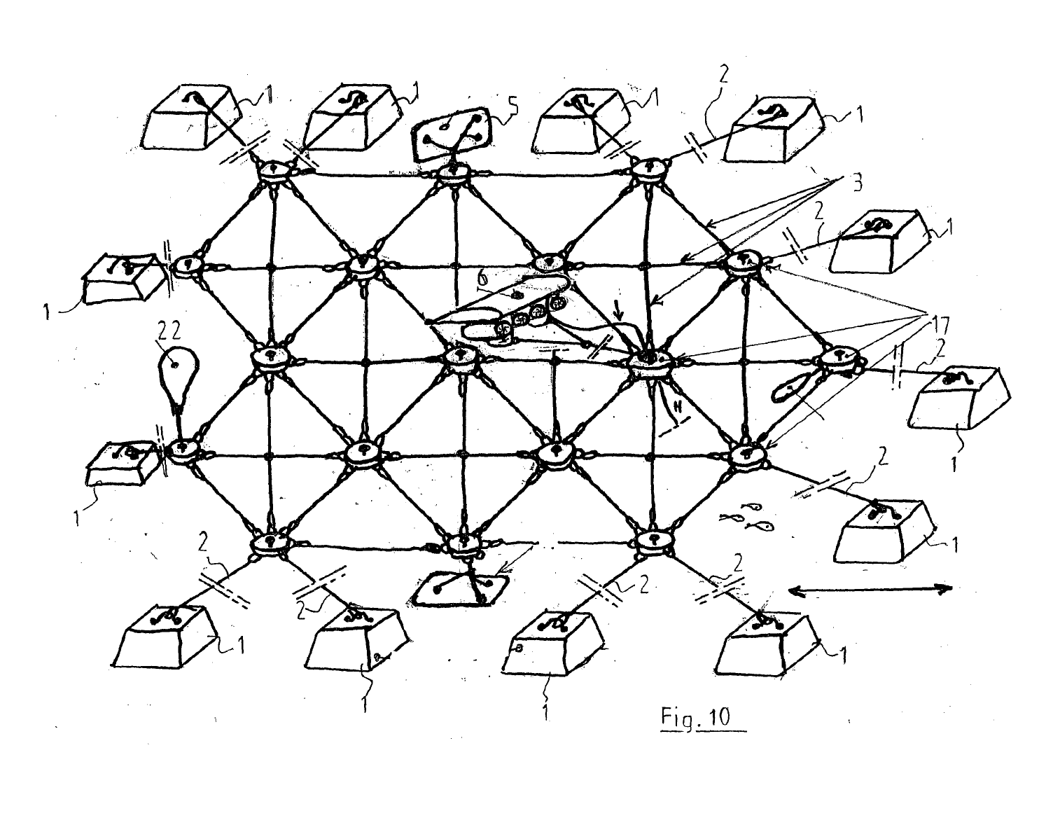

FIGS. 7 to 10 illustrate the fixing and the electric connections of a plurality of devices for recovering energy.

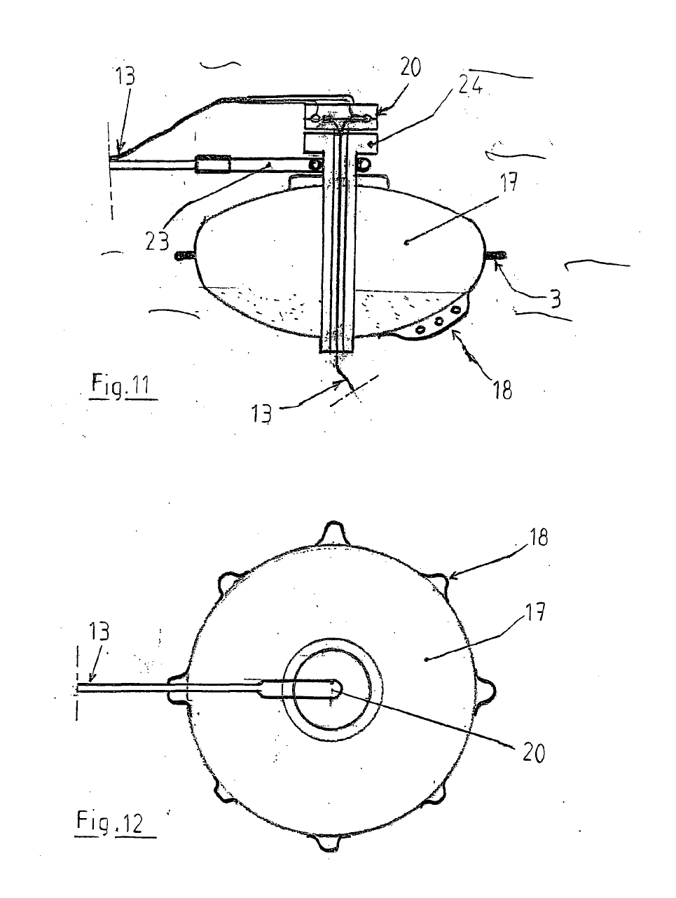

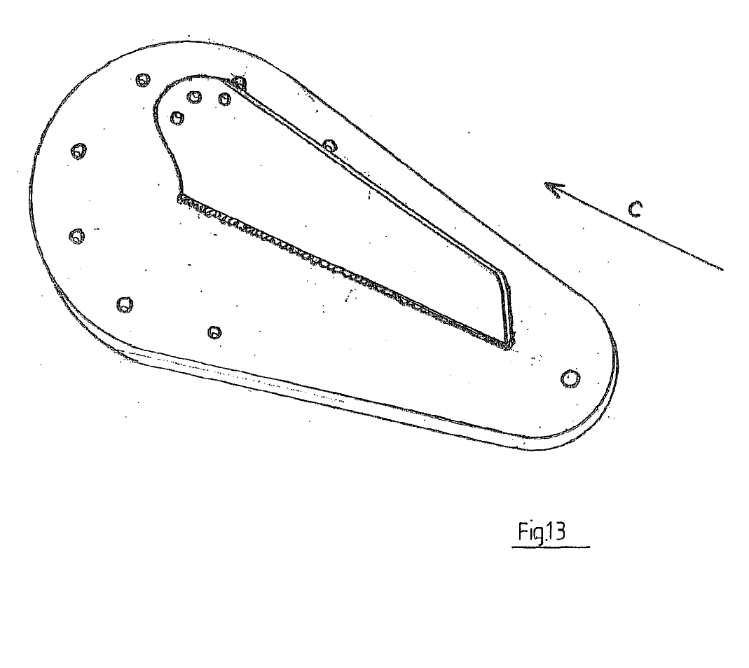

FIGS. 11 and 12 show a buoy for fixing devices for recovering energy according to one embodiment wherein the buoy enables the fixing and the electric connection of the device for recovering energy.

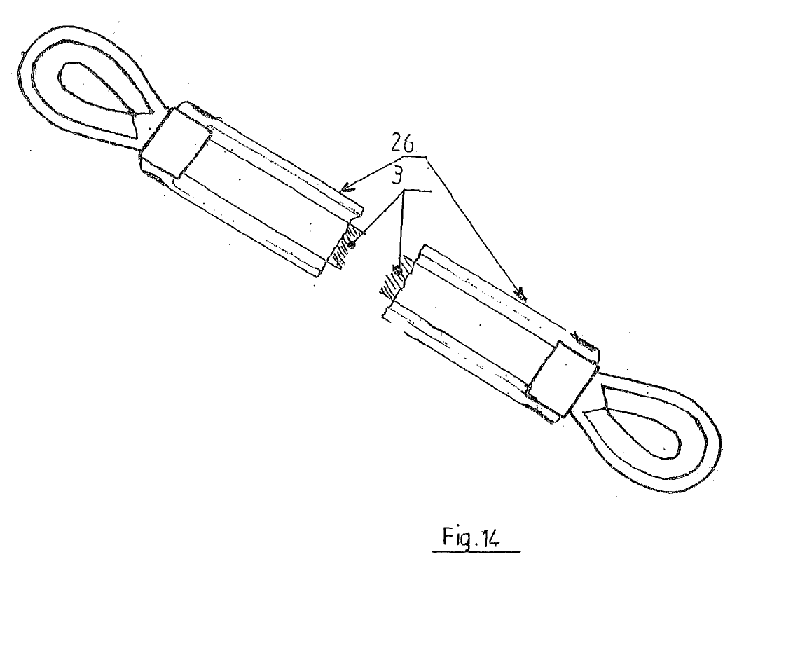

FIG. 13 illustrates an otter board used in the present invention.

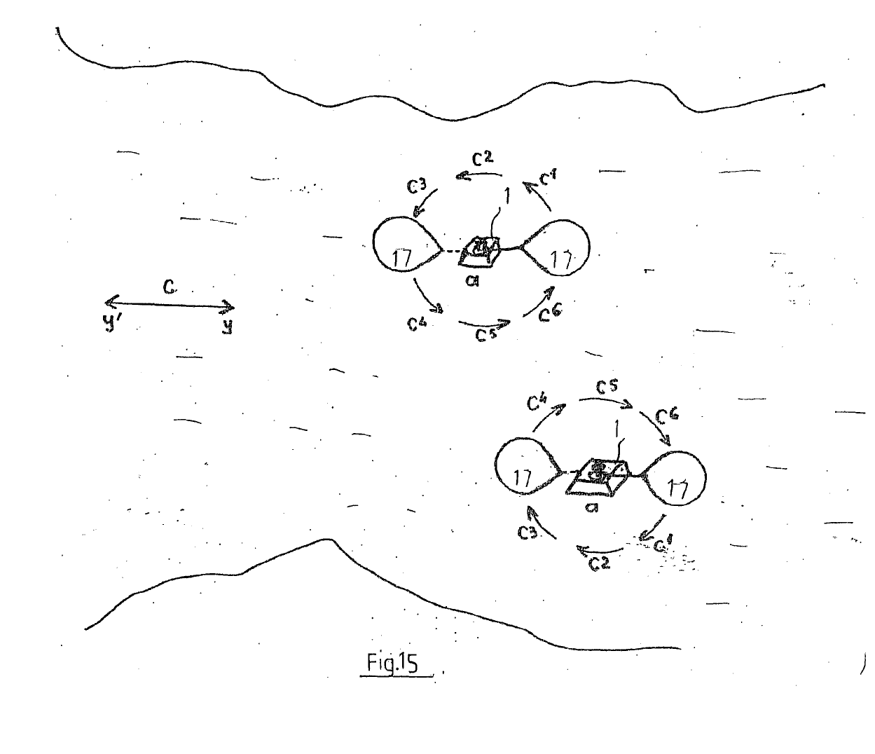

FIG. 14 illustrates a sling associated with a sleeve according to the invention.

FIG. 15 illustrates the rotational movement which the devices for recovering energy attached to a mooring are subjected to.

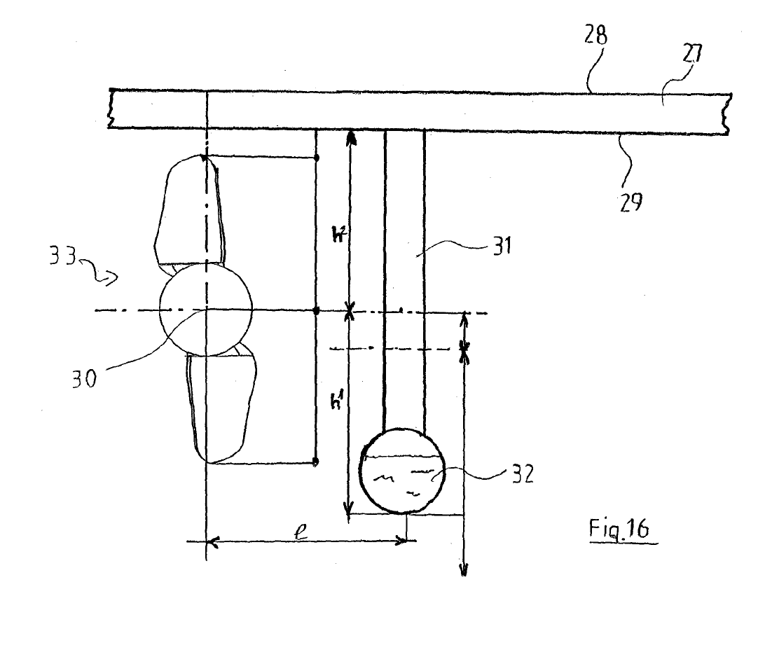

FIG. 16 shows the positioning of a power generator with respect to the keel and to the float of a device for recovering energy.

The support unit according to the invention is composed of a large enough mooring 1, preferably placed at the geographic centre of the current bed, wherein the devices for recovering energy 6 are to be operated.

On this mooring 1 is fixed a so-called main buoy rope 2 preferably long enough to reach the surface 9 of the sea and receive, or not, on the upper part thereof a buoy 7 and a device for recovering energy 6 and/or a signalling system.

At undefined spots, the buoy rope 2 shall receive attachment points 4 intended for receiving slings 3 made of steel or any other material, which when connected together by junction points such as rings or other types, will form stacked attachment frames. The devices for recovering energy 6 from marine current can be fixed at such crossings, using auxiliary buoy ropes 2′, preferably shorter than the main buoy rope 2.

A horizontal rudder provided on each device, will be programmed for operating the latter: either at the level of the frame, or above it or under it. Such driving will probably be controlled from an attitude data generator.

According to the invention, an even number of devices for recovering energy 6 are fixed at each crossing. Preferably, two devices are fixed on the same attachment point 4. Both devices 6 are controlled by a depth gauge so that one device will work above the frame plane and the other device will work in a lower plane. The two devices for recovering energy thus counterbalance each other. Besides, safety is enhanced, since if one of the two devices becomes defective, more particularly as regards the rudder or depth gauge thereof, the other device will compensate for it.

According to an alternative embodiment, a ballast composed of a buoy 34 having the preferred shape of a torpedo will be fixed on the same attachment point 4, in vertical opposition and for counter-balancing the upward pressure of the (Kerckove Type 1) or other types of devices for recovering energy 3. The buoy 34 preferably has a weight counterbalancing the upward pressure of the device for recovering energy or another device and will also comprise navigation means coupled to the device for recovering energy that it will balance. The buoy will be provided with its own production of energy by an auxiliary alternator or DC generator, so as to have a double circuit for controlling the navigation elements. Such double control enables the buoy connected these to the frame which they belong to, to comply with the depth they have been assigned to and which is constantly monitored by a depth gauge.

Buoy ropes 2 providing the spacing of the frame shall be attached to moorings 1 of the buoy ropes 2, on the sides of the frame. Alternatively, spacing boards 5, of the otter board type can also be used. Transversal slings 3 can be positioned for avoiding an irregular spacing and rigid parts can also be used instead of the slings 3, without affecting the function of the assembly. This is valid at least at the attachment points of the lateral moorings 1, but the number thereof is not limited.

The slings 3 shall preferably be of identical length, depending on their destination, but their length will be indefinite, since their size and resistance will be suitable for the types of devices for recovering energy 6 they will have to hold.

Longitudinal slings 3 will respond to the tension exerted by the devices for recovering energy 6. As many longitudinal slings 3 as required will be provided, and they may be rigid.

In order to facilitate the positioning and maintenance operations, and for cancelling the weight of the slings 3 by a buoyancy equal to their weight, these slings shall be equipped with a sleeve 26 made of polyvinyl or any other material resisting (more particularly sea) water. Said sleeves 26 can be pipes thermo-welded onto the ends of the slings 3.

The dimensions of the frame or support unit shall be undetermined. It shall be extensible, if need be, on the whole effective width of a marine current, and more particularly through the addition of new appropriate slings 3 and moorings 1.

The same is true as regards its length, which can be infinite. However, the appropriate number of longitudinal and lateral moorings 1 shall have to be provided.

Theoretically, the number of frames is not limited. However, it will be limited, for practical reasons:
watertightness of the devices for recovering energy 6
laying, fixing and maintenance conditions in the equipment fleet 6.
As there is no limit, from the marine point of view, as to the quantity of operational places (unlimited possibilities), there is no reason, considering the present state of the art, for increasing the depth of the working area. Using a single stratum can also be considered.

The frame can of course be given other geometric shapes such as a flat front, but the operating principle of the unit will not be affected whatsoever.

On the installation drawing proper, the moorings 1 will be directly fixed to the buoy ropes 2 from the barge 11 which positions these and which will let these go to the place planned for their position. The whole frame construction shall be mounted on the barge as one goes along since all the sling 3 lengths will be predefined. Provisional buoys shall be placed at the intersections and removed upon tethering the devices for recovering energy 6. Implementing the invention is thus very easy.

A ballast 22 shall then be provided for counterbalancing the tension of said device 6, or the contrary, if decided to operate it under the frame.

A torpedo-shaped buoy can be substituted for such ballast 22 when the device for recovering energy is positioned, and both devices shall preferably be coupled.

The attachment of the devices for recovering energy 6, as well as maintenance operations, which will probably be standard replacements, will surely be carried out by robots. As the length of the buoy ropes 2 and of all the buoy ropes 2′ holding the frame on the sea floor shall be equal to three times the height of water in their position, a tugboat 10 will be able to lift the frame and the devices for recovering energy 6, for repairing purposes. In case of important repairs and for standard replacements, the tugboat 10 will tow the barge 11 which will use its crane 12 to place the part to be repaired on the deck.

Multi-purpose mechano-welded connection parts can be used instead of rings. Slings 3 shall preferably be connected by shackles. For some technical reasons, rigid rods may be substituted for slings.

The device for recovering energy 6 according to the invention preferably comprises a float 27. It comprises a mechano-welded or polyester unit which can be made of any type of material known or to be known. The float 27 is of the “aircraft wing” type.

The device comprises a power generator which advantageously comprises at least one hydroelectric turbine 33. The turbine can move in rotation about an axis of rotation 30.

The device also comprises at least a keel providing balance to the device and supporting a vertical rudder, if need be.

Advantageously, the keel 31 has a longitudinal shape. It extends from the lower surface 29 of the float 27 toward the bottom of the sea or the river.

According to one alternative solution, the keel 31 is preferably provided with a ballast 32 able to receive a variable volume of water. As shown in FIG. 16, the ballast 32 is positioned at the free end of the keel 31.

In order to obtain a good hydrodynamic profile as well as a satisfactory stability in the current, and in spite of the turbulences created by the turbine 33, the keel 31 should advantageously extend beyond the axis of rotation 30 of the turbine 33. More precisely, the height h1 which separates the free end of the keel 31 and the axis of rotation 30 of the turbine 33 is at least equal to 20% of the height h2 between the axis of rotation 30 of the turbine 33 and the lower surface of the float 27. Free end of the keel 31 means the lower surface of the ballast 32 if it exists. Lower surface 29 of the float 27 means the lowest point of said surface 29.

Conventionally, the turbine 33 cooperates with an alternator for producing electricity. In a marine or fluvial environment, where the invention is used, upon rotating the turbine 33, the lack of means for holding the alternator on a fixed frame results in a rotation of the module unit and the absence of production of power. The module may start to candle, and thus apply significant forces on attachment points of the module, which could result in the shearing thereof. The keel 31 according to the invention enables to create a counterweight and to remedy such drawbacks.

According to a preferred embodiment, the height which separates the centre of gravity of the keel 31 from the axis of rotation 30 is equal to at least 20% of the height h2 between the axis of rotation 30 and the lower surface 29 of the float 27. More precisely, at least 50%.

The centre of gravity of the keel 31 is preferably located below the plane crossing the axis of rotation 30 of the turbine 33, more precisely between the end of the keel 31 and the plane crossing the axis of rotation 30 of the turbine 33.

In addition, or besides, the power generator and more particularly the turbine 33 may be mounted on the keel 31. However, the power generator and the keel are preferably mounted parallel. Then the power generator is attached to the lower surface 29 of the float 27, using a support 2 and the keel 31 is also attached to the lower surface 29 of the float 27. The power generator and the keel 31 are positioned side by side and face the current.

The power generator and the keel 31 are separated by a width I at least equal to the height h2 which separates the lower surface 29 of the float 27 from the axis of rotation 30 of the turbine 33. More precisely, the axis of rotation 30 of the turbine 33 and the centre longitudinal plane of the keel 31 are taken into account.

The present invention also relates to a marine device making it possible to recover and to transport to the dry land 16 the energy produced by one or more devices for recovering energy 6 from tidal currents, and more particularly so-called “Kerckove type 1” devices, without any restriction to this type of device.

In a tidal current, the stream follows one direction for six hours, starting from and stopping at a point also-called high tide slack water, and goes back the other way for approximately six hours to the starting-point, also called low tide slack water. Such alternative tidal current is not linear. After the low tide slack water, the stream goes landward, to the left, or to the right, depending on the proximity of land, and a left- or right-rotating motions can be noted. After the high tide slack water, the stream does not go back directly, but makes a circular motion. Nautical terms refer to a flood tide current and an ebb tide current as “on and off” currents.

Considering a mobile device for recovering energy of the “Kerckove Type 1”, described in application FR10/00513, anchored on a single mooring 1 and tethered by a single buoy rope 2, this device will completely and repeatedly rotate every twelve hours. If an electric cable 13 goes out of a collection box 14, it will wind by one turn every twelve hours.

The electric cable 13 transporting electricity to the dry land 16 is not a problem since it meanders on the sea floor 8 and goes up to the land on the floor.

The aim of the present invention is to remedy such problem.

No solution presently exists.

One solution consists in operating 2, 3, 4, 5 or 6 or any possible number of devices for recovering energy 6, knowing that the higher the number, the more difficult it is to find locations. The system using two devices will be preferred.

The “ Kerckove type 1” or other types of devices for recovering energy shall not be directly tethered to a mooring 1 but to metal buoys 17, the apex of which shall be equipped with a mounting trunnion 19 intended for receiving the buoy rope 2′ of the device for recovering energy 6, and making it possible to rotate by 360°. On their perimeters, the buoys 17 will be provided with fasteners 18 which will make it possible, through slings 3, to hold a central buoy 17 composed of a part required for buoyancy and preferably a part for connecting electric cables 13 for recovering the produced energy. An electric cable 13 reaching the dry land 16 or a larger collector 14 through the sea floor 8 is connected to the buoy 17. <<Kerckove Type 1 >> devices for recovering energy shall preferably be provided, on the upper part thereof, with a sealed rotating power extractor 25, rotating by 360°.

To summarize, the device for recovering energy 6 will constantly rotate by 360° about the axis of the mounting trunnion 19. Said mounting trunnions 19 and the buoys 17 supporting these will only make a flat circular movement, without any rotation. The aim is for the electric box 21 to be able to move, but not to rotate.

The aim is reached and the electric cable 13 which will connect the support unit and the dry land 16 through the bottom 8 of the sea will not be rotated. The energy contained in the tidal currents can thus be recovered 24 hours a day, except during the “slack water” times, using devices for recovering energy equipped with uni-directional turbines.

Such devices for recovering energy 6 are thus able to work 24 hours a day, at any depth in the pelagic zone, as well as on the surface. However, it should be noted that, during operations on the surface, the strength of waves will affect the rotating contact and the electric cable which will have to be reinforced.

The present invention will make it possible to use such support units, in tidal currents. Tidal currents involve a specific problem as regards the recovering of energy, for instance by <<Kerckove Type 1 >> or other types of devices. Currents are not only alternative, with high and ebb tide every 12 hours, they are rotating too.

A floating buoy 17 having shapes and dimensions adapted to each situation, will be used as a junction at the crossing of the slings 3 whereon it will be attached on the attachments points 18. End buoys 17 shall be connected to moorings 1 through cables or buoy ropes 2′ but shall be doubled, i.e. one will be placed upstream and one will be placed downstream.

Moorings 1 shall be provided at the back of the support units and as many intermediate moorings 1 as necessary shall be provided too. Otter boards 5 can also be used.

Buoys 17 shall comprise a hollow central axle 24, the apex of which will be provided with a mounting trunnion 19 for locking a rotating part 23 intended for receiving the end of the buoy rope 2′ of the <<Kerckove Type 1 >> or other types of devices for recovering marine energy 6.

A sealed rotating electrical contact 20 enabling the electric cable 13 to recover the electric power produced by the <<Kerckove type 1 >> or another type of device for recovering energy shall be provided on the upper part of the mounting trunnion 19. An electric cable 13 which will transport electricity to the dry land 16, through the hollow central axle 24 or another larger collector 14 will be connected to the rotating contact 20.

The fastener 18 will be used for tethering cables or buoy ropes 2 or 2′, or moorings 1.

This support unit system will make it possible to recover energy from tidal currents, on the sea floor 8, on one or more levels in the pelagic zone, on the surface of the sea 9 or in mixed areas. This kind of device does not exist yet and the manufacturing thereof is a batch production.

The slings 3 can be placed in tight pipes of the polyvinyl type, which shall be crimped onto the sling sleeves 26 such that the air contained in the sleeves 26 can counterbalance the weight of the slings.

Additional buoys can be used if counterbalancing and/or ballasting 21 is necessary.

The length and width of the device are indefinite and even infinite.

### REFERENCES

1. Mooring
2. Main buoy rope
2′. Buoy rope
3. Sling
4. Attachment point
5. Spacer board
6. Device for recovering energy
7. Buoy
8. Bottom
9. Surface
10. Tugboat
11. Barge
12. Crane
13. Electric cable
14. Electric collector
15. Transformer
16. Dry land
17. Buoy which can be ballasted
18. Buoy attachment point
19. Mounting trunnion
20. Rotating electric contactor
21. Electric box
22. Ballast
23. Rotating part
24. Hollow central axle
25. Electric power extractor
26. Sleeve
27. Float
28. Upper surface
29. Lower surface
30. Axis of rotation of the turbine
31. Keel
32. Ballast
33. Turbine
34. Buoy
h1 Height which separates the free end of the keel from the axis of rotation of the turbine.
h2 Height which separates the axis of rotation of the turbine from the lower face of the float.
I. Width which separates the axis of rotation from the turbine of the keel

1. A support unit designed for fixing a device for recovering energy from marine or fluvial currents, characterized in that it comprises a mooring and one main buoy rope extending from the mooring, with said buoy rope comprising several attachment points on each one of which a sling is fixed, whereon a device for recovering energy is fixed.

2. A support unit according to claim 1, comprising a plurality of slings fixed to an attachment point of the main buoy rope and connected with each other so as to form a frame and buoy ropes retaining said devices for recovering energy are attached at the crossing of the slings.

3. A support unit according to claim 1 comprising, at the crossing of slings, a mean for fixing whereon a device for recovering energy is fixed.

4. A support unit according to claim 1, wherein the mean for fixing comprises a ballasted buoy comprising a float designed to provide the buoyancy of the buoy, and a mounting trunnion designed for fixing a buoy rope connected to a device for recovering energy.

5. A support unit according to claim 1, wherein the buoy is provided with attachment points designed for receiving slings and/or buoy ropes connected with a mooring.

6. A support unit according to claim 4, wherein the buoy comprises, on the mounting trunnion, a rotating sealed electrical contact designed for providing the connexion with an electric cable extending from a device for recovering energy.

7. A support unit according to claim 1, wherein the buoy comprises a duct going through the height thereof from the mounting trunnion, through which goes an electric cable designed for transporting the power produced by the device for recovering energy.

8. A support unit according to claim 4, comprising a floating electric box attached between slings and so configured as to receive an electric cable from the device for recovering energy.

9. A support unit according to claim 1, wherein the electric box comprises an electric cable designed for transporting the electricity produced by the device for recovering energy.

10. A support unit according to claim 2, wherein the slings comprise a sleeve enclosing air so as to balance the weight thereof.

11. An energy-recovering system comprising a support unit according to claim 1, characterized in that it comprises a device for recovering energy comprising: a hydrodynamic float, a power generator comprising a at least one turbine, a power generator holder and at least a ballasted keel providing stability to the device, said power generator is held under the float by the holder so that the height separating the end of the keel from the axis of rotation of the turbine is at least equal to 20% of the height between the axis of rotation of the turbine and the lower face of the float.
